(19) United States
(12) Patent Application Publication
(10) Pub. No.: US 2018/0369054 A1
(43) Pub. Date: Dec. 27, 2018

(54) Dynamic Aerobic Device for Stretching and Improving the Flexibility of the Feet

(71) Applicant: Compañia de Ballet David Campos S.L., Barcelona (ES)

(72) Inventor: David Campos Cantero, Barcelona (ES)

(21) Appl. No.: 15/563,048

(22) PCT Filed: Jun. 15, 2016
(86) PCT No.: PCT/ES2016/000067

§ 371 Date: Sep. 29, 2017

(30) Foreign Application Priority Data
Jun. 15, 2015 (ES) P201530831

(51) Int. Cl. A61H 1/02; A63B 21/00; A63B 21/065; A63B 23/035; A63B 23/10

(52) U.S. Cl. CPC A61H 1/0266; A63B 21/00043; A63B 21/065; A63B 21/4015; A63B 21/4034; A63B 2023/006; A63B 23/03508; A63B 23/10; A61H 2201/1642; A61H 2201/1652; A61H 2201/1269; A63B 21/4035

(57) ABSTRACT

A dynamic aerobic device for stretching and improving the flexibility of the feet, formed by: a foot stretcher and a removable handle, as well as a strap that can be positioned either on the calf or above the knee so as to allow two different uses. The device includes: a central projection of suitable dimensions corresponding to part of the sole of the foot; a coupling mechanism with an internal screw thread and an external channel; a removable weight on the outsole of the foot stretcher; and a securing elastic half-sock that is wider at the open end than at the closed end, said half-sock including convex faces and rounded edges and corners, having different densities, and being provided with a band on the upper edge of the open end.

### FIELD OF THE ART

Instruments for the preparation and training of classical ballet.

### STATE OF THE ART

The devices for stretching and improving the flexibility of feet which currently exist are unsuitable for solving important needs posed by students and dancers of classical ballet, or other sportspeople who need to stretch and improve the flexibility of their feet. Although the device for stretching and increasing the flexibility of the feet, protected in its day with model U 9700652, was at the time a great novelty in forming and strengthening the feet of classical ballet dancers, practice over 17 years has shown that it has shortcomings which hinder notably the result of moulding the foot, the aerobic function which should accompany its use, and other functional possibilities which the practice of classical ballet, increasingly demanding, or foot stretching exercises require today.

### EXPLANATION OF THE INVENTION

### Technical Problem

There are currently a number of devices to facilitate stretching and flexibility of a classical ballet dancer's feet. The first and oldest is the “Device for stretching and improving the flexibility of the foot”, protected by David Campos with model U 9700652. Its long, one-piece handle has been shown to be very useful for guiding the foot safely with the hand to certain positions (without forcing the arm or risking breakage), but it also has the drawbacks of complicating or preventing the performance of certain very important movements and foot training or in Arabesque with the device in position. Secondly, the device in itself is excessively heavy, making it unsuitable for certain exercises and insufficient for others, in particular for obtaining a suitable degree of aerobic activity to ensure optimum blood flow and, consequently, oxygenation of the foot muscles. Thirdly, the upper front projection, an element of the greatest importance in the shaping of the foot, was revealed to be excessively long and also too flat in its highest part. This shaping has been shown to be not enough satisfactory in performing its function of stretching and improving flexibility, delaying or complicating the final result sought, as well as in the positioning of the device using its lower part or sock. And, fourthly, the tubular rubber piece used to fasten the foot to the mould of the earlier device has a number of drawbacks: it is difficult to take off and put on; it exerts too much pressure on the top of the foot and the heel, where it is not necessary, while the pressure on the bottom of the foot and the toes area is insufficient. Its shape and its termination are also unsuitable for performing foot exercises with the device in place and supported on the floor; this is because, as it has an uneven finish, its use in contact with the floor can affect the stretching forces applied by the tubular fastener to the foot.

As for the second device, which was the subject of U.S. patent application Ser. No. 14/277,136 and PCT WO 2014186502, and which we will oppose in the suitable procedural moment because we consider it has no new features, does not introduce any innovation or technical improvement in the functionality of stretching and improving the flexibility of the foot over the David Campos device referred to above. The only new feature introduced by this apparatus is the possibility of separating the handle from the part of the device (something unconnected with the device's stretching function) by means of a simple external thread (a solution which is obvious for any person skilled in the art); however, as can be seen from the description given in the patent application, it is not designed to allow its aerobic and independent (without the handle or manual assistance) correct use; because it lacks the correct measurements, it is uncomfortable and even dangerous to use so close to the skin, and because it lacks a suitable fixing and fastening system which, together with the shaping specialities we have referred to, allow the safety development of the function of stretching and increasing the flexibility of the foot expected from this type of device, while allowing the required training exercises to be performed. On the other side, the tubular fastener in the device is closed at the bottom, but with an angular shape which is unsuitable for working with the foot stretcher on it on the floor. Neither does its tubular structure adapt correctly to the requirements of the anatomy of the foot applied on the device.

Other types of subsequent devices which we have seen in the state of the art are a long way from finding a solution to the technical problems solved by the invention which we would like to protect with this application.

### Proposed Solution

It is important to note that this description, together with the drawings accompanying it, is provided as an example; it is not exhaustive, is based on one of the best ways of implementing it in practice, and is not intended to limit other equivalent embodiments of this invention. Other non-substantial modifications will be obvious for a person skilled in the art in the light of what is explained here.

To solve the problems mentioned, after many years of studies with different variations and prototypes, a new device is provided which is based on a lower part or foot stretcher (2) approximately 43 cm long, and an upper part or handle (1) approximately 33 cm long, and is defined by the combination of the following technical solutions.

Firstly, the new device is formed of two pieces joined together by a coupling mechanism with an internal screw thread and external channel, defined expressly to respond to the device's own functional requirements. This internal screw system is able to connect the two pieces safely, while allowing the lower part or foot stretcher (2) to be used on its own and independently. For this reason, a coupling mechanism is designed with an internal screw thread in both the male part (19) and the female part (13) with an external channel (18). The male screw thread (19) is located inside a cylindrical metal piece (17) which, attached to the upper part of the foot stretcher (21), has a concave channel (18) on the outside. At the bottom of a cylindrical central hollow in said cylinder there is an internal cylinder (20) which houses the male screw thread (19) in its external perimeter. The female screw thread (13) is in the inside of a cylinder (14) which emerges from the centre of a flat circular piece (15) attached to the lower part of the handle (16) of the device. The two screw threads fit together by inserting the female screw thread (13) of the handle on the internal male cylinder (20) of the foot stretcher; wherein the screw threads are coupled easily to their end with a short and easy turns, resulting in a coupling of the two pieces which is stable, strong and safe for the user. The pieces are separated just as easily and safely, with a few turns in the opposite direction.

Secondly, in the redefinition of the insole (8), the part of the foot stretcher in contact with the foot, the length of the central projection (9) is reduced from 14 cm in the previous device to 7.5 cm in the current one; in addition, the slope on both sides of the projection is made less pronounced by changing from an approximate width from the base of 4 cm in the previous device to an approximate width of 5 cm in the current one, with this projection entering through the centre to a flat area of approximately 9 cm long.

Thirdly, depending on the resistance capacity of the manufacturing material, the volume and, consequently, the weight of the foot stretcher (2) is reduced as much as possible to make it as light as possible. A weight (11) of between 700 g and 1000 g is also designed (other heavier or lighter weights are also possible for special requirements, and their use is obvious for a person skilled in the art) which can be attached to, or separated from the sole (12) of the foot stretcher (2).

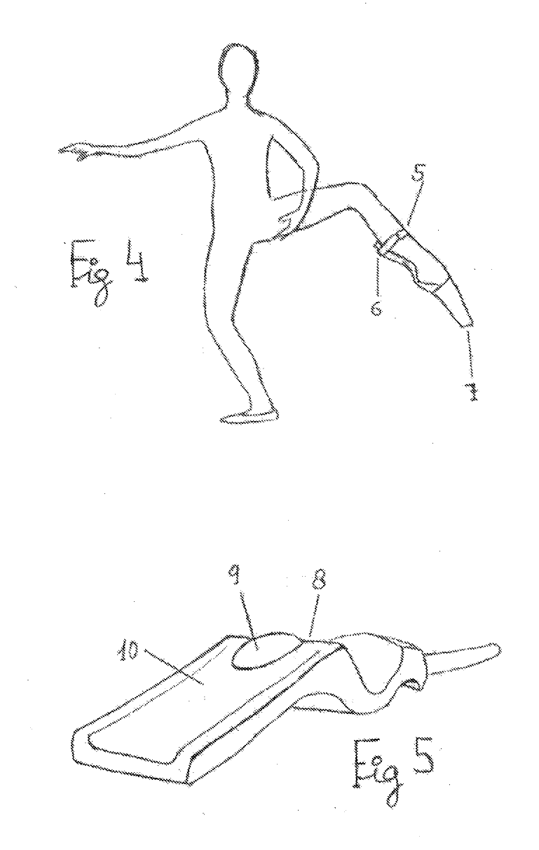

Fourthly, a strap approximately 44 cm long and 3 cm wide is designed (other widths and lengths are also possible, as is the possibility of making the part in contact with the leg wider for greater comfort; both of these features are obvious for a person skilled in the art). This strap is able to fasten the leg to the complete device by fastening it above the knee (3), just above the top of the handle (4), or just to the foot stretcher (2) by fastening it at the height of the med-calf (5), using the concave channel (18) (other forms of fastening—wrinkling, magnets, Velcro® etc. —on this piece or the top of the foot stretcher are also possible and obvious for a person skilled in the art) which forms the coupling piece affixed to the top of the foot stretcher (21). In both cases, the device is attached by its lower part to the leg using the fastening elastic half-sock which grasps both the top of the foot and the lower part of the foot stretcher by the sole (7), where the fastening elastic half-sock applies the correct pressure to the foot in the insole (8) to achieve the desired stretching and flexibility effect. In the first case, the device fastens the whole leg, so that the knee is immobilised, allowing stretched leg exercises to be carried out with the hands free (FIG. 3). In the second case, the leg is only fastened to the foot stretcher by the calf (5), allowing knee bent exercises to be carried out with the hands free (FIG. 4). It is important to note that this sheath performs two functions: 1) it fastens the device to the leg, and 2) it stretches the foot on the insole (8) of the device. It is the combination of these two elements (strap, in its two alternative positions—3 and 5—on the one hand; and fastening elastic half-sock at the lower end of the device, on the other) which allows the dancer freedom of movement, while the foot stretcher performs its beneficial function on the dancer's foot. For the performance of these functions, both the length of the handle (1) and of the foot stretcher (2) are fundamental, as well as it is also fundamental the position in which the strap is placed.

Fifthly, a fastening elastic half-sock (FIGS. 12 to 16) is developed, which responds specifically to the anatomical requirements of the foot attached to the device. It is trapezoidal (22) in the longitudinally shape, with an open long side (23) of approximately 13 cm and an opposing short side, of approximately 8 cm, wherein a closed end (24) is located; the distance separating them is approximately 20 cm. These approximate measures, maintaining their basic design principles, may be varied to be adapted to a new format of foot stretcher or feet with special dimensions. This basic trapezoidal shape (22) (in the sense that it will continue to be this shape, even if the parallel sides or the side faces are bulged or rounded at the corners), whether considered on the flat plane or in profile, obeys the need to distribute the pressure in a balanced way on the relevant parts of the foot according to its natural form, so that the perimeter of the foot stretcher is adapted, depending on the internal volume and the force required on each area of the foot in the corresponding part of the insole (8) of the foot stretcher (2), to the stretching and flexibility functional requirements of the different parts, with particular attention paid to protecting the Achilles tendon. The same objective is sought, as a complement to the above, by the bulging of the upper face (31) and the lower face (33) of the fastening elastic half-sock. The special shape given to the perimeter of the open side (23) is also designed for the same purpose. This shape consists of a straight finish on the edge of its upper half (28) (in direct contact with the instep) of approximately 13 cm (although other lengths and convex curves are possible and obvious for a person skilled in the art) and a concave one on the edge of the lower face (29) with a radius of approximately 6 cm (although other radii or concave shapes are also possible and evident). This lengthening of the upper face and concave profile of the lower allows the correct pressure to be applied to the instep, without wrinkling or overloading the lower part of the bridge. Also important for the balanced distribution of forces is the closed end (24) of the lower part of the fastening elastic half-sock adapted to the shape of the internal end of the foot stretcher, as it projects the force uniformly onto the lower part of the bridge and of the foot, when it finds support or precise resistance in all its points, and particularly the rounded corners and edges (26). This adapted shape of the fastening elastic half-sock, with its perfectly rounded corners and edges (26), also allows exercises to be carried out with the foot stretcher on the floor with flexibility and a safe support, without forcing or damaging the rubber or altering its elastic action on the foot stretcher.

A further two features of the fastening elastic half-sock which contribute to defining the degree of pressure of the foot on the foot stretcher (2) are the degree of density of the silicone (or equivalent material) and the possibility of fitting one sock inside another for its application. First, the force can be increased or reduced by increasing or reducing the density of the silicone at the moment of manufacture on a scale of between 20 and 70 shores. Second, by manufacturing the fastening elastic half-sock in different densities (between 20 and 70 shores) and in such a way that all of them can fit in another sock, a possibility which defines the fastening elastic half-sock that we intend to protect; the force of action on the foot can be increased or reduced by adding or removing fastening elastic half-socks in its application.

It should also be emphasised that the upper, flat edge (28) of the open side (23) of the top of the fastening elastic half-sock is finished with a edge band (34) approximately 4 mm thick, which protrudes outwards by about 1.5 mm (other measurements are possible and obvious for a person skilled in the art). The purpose of this is to make it easier to roll and unroll the fastening elastic half-sock on the foot applied to the foot stretcher, while also strengthening the upper end and its ability to apply force to the foot.

Finally, it should be noted that, to apply it to the foot stretcher, the fastening elastic half-sock must be rolled up from its open side (23) until just before the closed end (24), in order to unrolled it, when the foot applied to the foot stretcher has been inserted into the resulting cavity, taking in both the upper part of the foot with the upper part of the fastening elastic half-sock finished with the edge band (34), and the sole (12) of the foot stretcher with its lower part finished with the concave curve (29).

### Advantages

The proposed dynamic and aerobic device for stretching and increasing the flexibility of the foot has the following advantages:
1. It leaves the hands free because the device can be fastened to the dancer's foot with no need for it be held or guided with the handle.
2. When the leg is fastened to the whole device (above the knee or top end of the handle), the leg is ready for the performance of exercises with a rigid leg (FIG. 3).
3. When the leg is fastened to the device alone (by the mid-calf -5- and with the channel -6- of the joining piece), the knee is completely free for performing a variety of different exercises (FIG. 4).
4. When the device is applied, exercises accompanied or guided with the arm by the handle (1), unaccompanied straight leg exercises and exercises with free movement of the knee can be performed.
5. These greater possibilities of exercise promote the dancer's blood circulation and aerobic activity, particularly in the musculature of the foot, leg and hip joint.
6. This beneficial effect increases thanks to the possibility of using the foot stretcher for light exercises without weights (11) and exercises using weights (11). The aerobic activity obtained with these two types of exercises, especially when a weight (11) is used, stimulates the oxygenation of the foot area, which is always more difficult to achieve, and thereby improves the results in flexibility and stretching of the soft areas of the joint which are sought with the device.
7. The concave channel (18) allowed by the fastening piece fixes the fastening strap in the optimum position to fix the device and carry out exercises without discomfort. The user experiences no harm or discomfort during the exercises.
8. The lengthways shortening and smoothing of the sides of the projection (9) located below the sole of the dancer's foot makes it easier to position the sock of the foot stretcher, improves the adjustment of this part of the foot to the device, in both the flat and sideways positions, increases the effect of the action of the device on the instep-bridge area because of its smaller length, and also prevents slipping or incorrect positions. This translates, in addition to greater comfort and ease of use, into more efficient stretching and increased flexibility, precisely in the parts of the foot which are most delicate and important for the dancer.
9. The fastening elastic half-sock adapted to the anatomy of the foot applied to the device allows pressure to be distributed in a balanced way, focusing on the most important parts, while at the same time preventing excessive pressure on other delicate parts such as the instep, heel or Achilles tendon.
10. The closed end, rounded at the corners and edges (26), adjusted to the shape of the closed end (24) of the foot stretcher, allows the sock to be fastened perfectly to the foot stretcher, and means that exercises can be carried out with the foot stretcher on and resting on the ground, without altering the elastic forces on the foot.
11. The different densities with which the fastening elastic half-sock is manufactured, and the possibility of fitting one fastening elastic half-sock inside another, allows them to be adjusted to different foot sizes and different force requirements.
12. The edge band (34) which protrudes rounded above the top edge of the open side of the fastening elastic half-sock makes it easier to roll and unroll the fastening elastic half-sock, and also strengthens the action of this part of the upper face on the foot.

### DESCRIPTION OF THE FIGURES

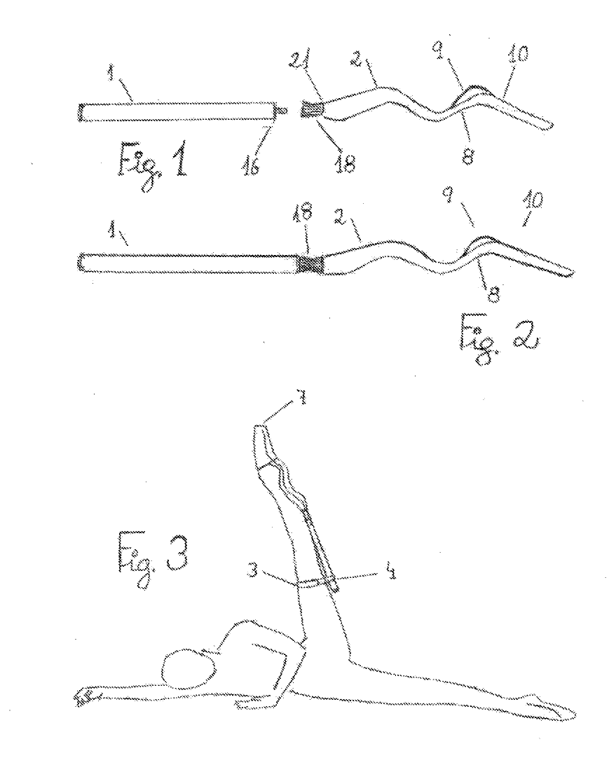

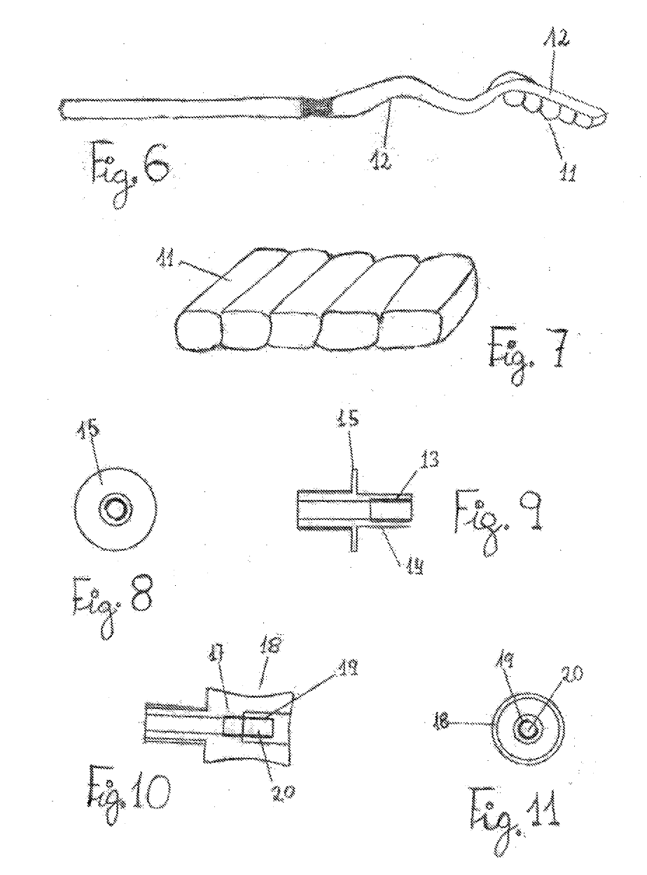

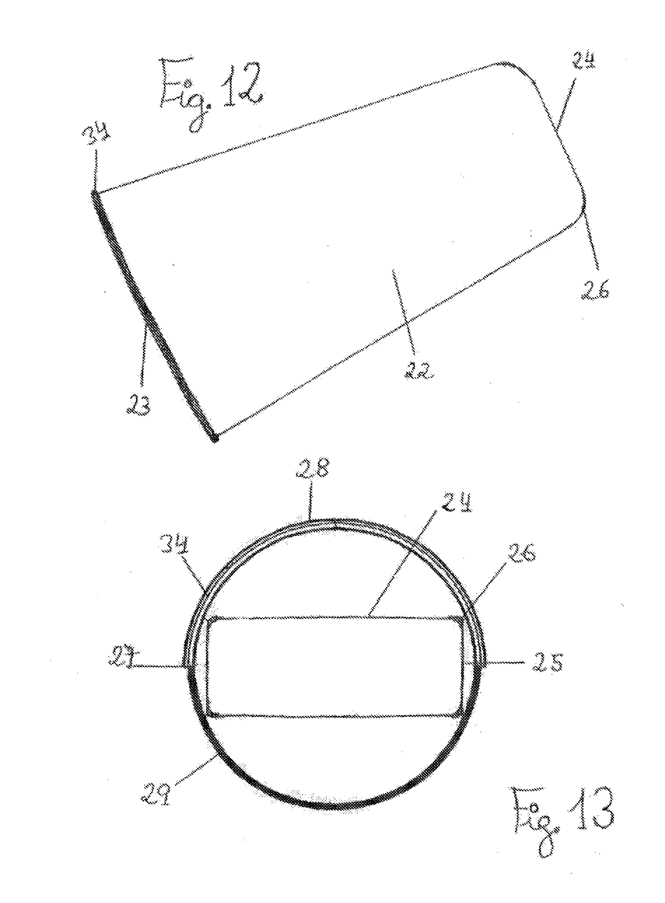

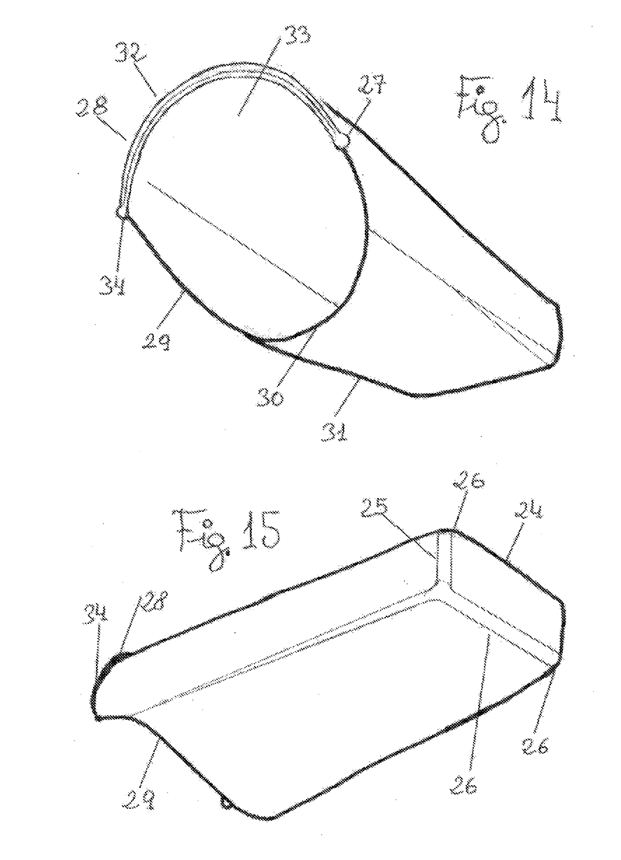

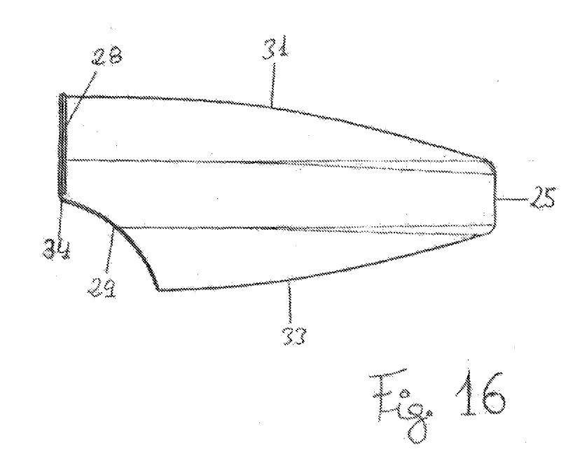

To illustrate the proposed solutions, the following figures are provided: drawing of the full device with the handle (1) separate (FIG. 1) and attached to the foot stretcher (2) (FIG. 2), drawing of the strap in its two application positions (FIGS. 3 and 4), drawing of the new projection (9) (FIG. 5), drawing of the weight (11) applied to the foot stretcher (FIG. 6) and on its own (FIG. 7), detailed drawings of the coupling mechanism by an internal screw thread with external channel from the front (FIGS. 8 and 11) and in cross-section (FIGS. 9 and 10); drawing of the flat fastening elastic half-sock seen from above (FIG. 12), drawing of the fastening elastic half-sock from the open side (23) with the closed end (24) furthest away (FIG. 13), drawing of the fastening elastic half-sock seen from below the lower right corner of the open side (23)—behind—(FIG. 14), drawing of the fastening elastic half-sock seen from below from the lower right corner of the closed end (24)—at the front—(FIG. 15) and drawing of the fastening elastic half-sock seen in profile from the right side (FIG. 16). It should be noted that these figures are provided for illustrative purpose and, together with the description, are merely to explain the principles of the proposed invention. The intention is not to limit the invention to the form given in these illustrations; consequently, the elements of which it is composed may take other forms not necessarily included in these drawings.

### DESCRIPTION OF AN EMBODIMENT

The manufacturing process consists of the following steps: Selection of the woods and materials most appropriate for the function to be carried out by the device.

The wood is positioned in the pantograph to carve the exact upper shape. Then, piece by piece, it is installed on a lathe to give the rounded finish of the rear part, wherein the metal connecting piece will be inserted later on. Once it has been shaped, the wood is then polished, taking care not to modify in the slightest way the functionally relevant shape.

The coupling mechanism by an internal screw thread with external channel is made up of three pieces. The starting point is a metal cylinder, wherein a concave channel is dug out of the outside. Equally, a cylindrical cavity is drilled in its centre, and a smaller cylinder with the male screw thread inserted is situated on such centre (FIG. 10). From another side, another piece with a flat circular base is prepared, out of the centre of which a male cylinder containing inside the female screw thread emerges (FIG. 9).

The wooden pieces are then painted, and a final coat of colourless varnish is applied to provide greater resistance to blows and scratches.

Once the pieces have been painted, the metal connecting elements are assembled: the flat disc from which the cylinder containing the internal female screw thread emerges is placed at the lower end of the handle, and the concave cylinder with the external male screw thread in the inferior cavity is placed in the upper part of the foot stretcher.

The weight is formed by adding small metal balls to a flat bag, which has on one of its faces a joining element which is complemented with the other element placed on the opposite side to the pressure part at the lower part (at toe level) of the foot stretcher.

Once the mould has been manufactured, the fastening elastic half-sock is made by injecting sanitary silicone for direct contact with the skin into the corresponding mould for the desired strength and density. When cool, it is removed from the mould.

1. Dynamic aerobic device for stretching and improving the flexibility of the feet which, on the basis of the techniques and materials used in industries of instruments for the training of classical dancers, is characterised by dividing the device into two pieces: an upper piece or handle (1) approximately 33 cm long, and a lower piece or foot stretcher (2) approximately 43 cm long in total, in such a way that the device allows the foot stretcher to be fastened to the leg, either above the knee (3) fastened by a strap at the top end, with or without channel, of the handle joined to the foot stretcher (4); or at the height of the mid-calf (5) by a strap mounted on the channel of the joining piece which crowns the handle-less foot stretcher, or directly on the top end of the handle-less foot stretcher (6); and by its bottom end by a fastening elastic half-sock which grips both the foot and the sole of the foot stretcher (7).

2. Dynamic aerobic device for stretching and improving the flexibility of the feet according to claim 1, which is characterised in that it has, in the insole (8) area, just at the exit from the heel cavity, a central projection (9) approximately 7.5 cm long and 5 cm at the base, with a gentle symmetrical descent from a central height of approximately 8 cm until it opens out, starting at the sides in the area where the toes are held (10).

3. Dynamic aerobic device for stretching and improving the flexibility of the feet according to claim 1, which is characterised in that it has a removable weight (11) in the sole of the device (12).

4. Coupling mechanism by internal screw thread with external channel which, for greater utility of claim 1, is characterised in that it allows the handle and foot stretcher to be joined and separated by means of an internal screw thread coupling mechanism with external channel formed of two elements: one which holds the female screw thread (13) in the inside of a cylinder (14) attached to a flat circular base (15) connected to the bottom end of the handle (16); and another cylindrical element (17) which may be longitudinally concave or with a channel (18) wide on the outside, which mounts the male screw thread (19) on an internal cylinder (20) located in the centre of a cylindrical cavity located in the centre of the piece, attached to the top end of the foot stretcher (21).

5. Fastening elastic half-sock especially designed to apply and fasten the foot on the foot stretcher which, manufactured with sanitary silicone for contact with the skin, is characterised in that it has a base (22) delimited by two unequal parallel ends, a longer open side (23) approximately 13 cm on the flat, and another shorter side which defines a closed termination (24), and a height of approximately 20 cm between the two; the upper and lower faces of the fastening elastic half-sock are joined in a termination which, with a height (25) and width (24) adapted to the dimensions of the bottom end of the foot stretcher, has rounded corners and edges (26) and closes the fastening elastic half-sock at its bottom end; the open side has an opening (27) with a perimeter of approximately 27 cm, wherein the top half of this length (28) is flat, or very slightly curved, in a length of approximately 13 cm and the edge of the lower part describes a concave arc (29); the upper face in its natural form (with no pressure) has a convex curve both laterally (30) and longitudinally (31); the lower face has a convex curve both laterally (32) and longitudinally (33).

6. Fastening elastic half-sock especially designed to apply the foot on the foot stretcher, manufactured with sanitary silicone suitable for contact with the skin, according to claim 5, which is characterised in that the upper termination, which is flat or very slightly curved on the open side, has along its whole length a edge band (34) approximately 4 mm thick.

7. Fastening elastic half-sock especially designed to apply the foot on the foot stretcher, manufactured with sanitary silicone for contact with the skin, according to claim 5, which is characterised in that it is manufactured with a scale of different densities of silicone, comprised between 20 and 40 shores.

8. Fastening elastic half-sock especially designed to apply the foot on the foot stretcher, manufactured with sanitary silicone for contact with the skin, according to claim 5, which is characterised in that it allows one fastening sock to be inserted inside another.
